(19) United States
(12) Patent Application Publication
(10) Pub. No.: US 2012/0112557 A1
(43) Pub. Date: May 10, 2012

(54) Solar Panel with Reconfigurable Interconnections

(76) Inventor: Brian M. Sager, Menlo Park, CA (US)

(21) Appl. No.: 13/269,580

(22) Filed: Oct. 8, 2011

Related U.S. Application Data
(60) Provisional application No. 61/391,636, filed on Oct. 9, 2010.
(60) Provisional application No. 61/393,308, filed on Oct. 14, 2010.

(51) Int. Cl. H02B 1/24

(52) U.S. Cl. 307/112

(57) ABSTRACT

An array of photovoltaic cells are arranged as a matrix. A plurality of interconnections are arranged between the photovoltaic cells, the interconnections being switchably addressable to form serial or parallel connection arrangements.

### RELATED APPLICATIONS

The present application claims priority to U.S. Provisional Application 61/391,636, filed Oct. 9, 2010, and entitled “SOLAR PANEL WITH RECONFIGURABLE INTRAPANEL SOLAR CELL INTERCONNECTIONS”, which is incorporated herein for every purpose; and claims priority to U.S. Provisional Application 61/393,308, filed Oct. 9, 2010, and entitled “SOLAR PANEL WITH RECONFIGURABLE INTRAPANEL SOLAR CELL INTERCONNECTIONS”, which is incorporated herein for every purpose.

### BACKGROUND

Solar cells and solar cell modules convert sunlight into electricity. Traditional solar cell modules are typically comprised of polycrystalline or monocrystalline silicon or thin-film solar cells mounted on a support with a rigid glass top layer to provide environmental and structural protection to the underlying silicon based cells. This configuration has a plurality of solar cells interconnected to form “strings” of cells, which describe the manner in which the solar cells are electrically interconnected in the solar panel or module. These strings of cells in the solar panel are typically connected in a permanent, non-reconfigurable manner. In this way, a solar panel may have all the solar cells connected together in series, which yields a particular current output and voltage output from the solar panel when exposed to light at a particular condition such 1 sun, AM1.5G.

Drawbacks associated with traditional solar module package designs, however, have limited the ability to adapt the solar panel to particular conditions at any installation site. Some companies, such as Tigo Energy through its product Module Maximizer, and National Semiconductor through its SolarMagic product, as well as others have opted to provide microinverters or other power management electronics to improve and optimize the overall power output from solar cells. However, these are all relatively expensive, incur additional installation time and cost, and are limited to the particular cell stringing of solar cells in the panel that is locked in at the solar panel factory and not-reconfigurable in the field.

Although subsidies and incentives have created some large solar-based electric power installations, the potential for better performance and lower cost at greater numbers of these large solar-based electric power installations has not been fully realized. There remains substantial improvement that can be made to photovoltaic cells and photovoltaic modules that can improve their performance at the system level and therefore create much greater market penetration and commercial adoption of such products, particularly for large scale installations.

### SUMMARY OF THE INVENTION

An apparatus, system and method are provided for configuring photovoltaic cells. An array of photovoltaic cells are arranged as a matrix. A plurality of interconnections are arranged between the photovoltaic cells, the interconnections being switchably addressable to form serial or parallel connection arrangements.

### BRIEF DESCRIPTION OF THE DRAWINGS

The teachings of the present invention can be readily understood by considering the following detailed description in conjunction with the accompanying drawings, in which:

FIGS. 1 and 1A show an example solar panel system.

FIGS. 2 and 2A show another example solar panel system.

FIG. 3 shows another example solar panel system.

FIG. 4 shows another example solar panel system.

FIG. 5A shows another example solar panel system.

FIG. 5B shows the solar panel system of FIG. 5B in operation.

FIG. 6 shows an example switching arrangement.

FIG. 7 shows an example wiring arrangement.

FIG. 8 is an example of inverter stochastic data.

### DETAILED DESCRIPTION

Although the following detailed description contains many specific details for the purposes of illustration, anyone of ordinary skill in the art will appreciate that many variations and alterations to the following details are within the scope of the invention. Accordingly, the exemplary embodiments of the invention described below are set forth without any loss of generality to, and without imposing limitations upon, the claimed invention.

In a solar panel, the photocurrent of that panel is determined by the energy harvesting area of the solar cells incorporated into that panel, while the voltage of that panel is built up as the sum of the series interconnected solar cells in that panel. The larger the cell surface area, the higher the current, the lesser the cell surface area, the lesser the current. The more the cells in series, the greater the voltage, the fewer the cells in series, the lesser the voltage. At a given power output, a solar panel can be assembled from a small number of large cells or a large number of small cells. Irrespective of the selected panel design architecture, the current and voltage of the panel are conventionally fixed attributes, varying only as the cells degrade over time.

However, by varying in the field the number of cells that are placed in series or in parallel, the voltage from the panel can be tuned in the field, which can be of particular importance in configuring solar panels suitable for conditions at an installation site. Since power is determined as the multiple of current and voltage, changing the voltage of a panel changes its power output. Changing the intrapanel reconfiguration is, therefore, advantageous. Further, by changing the intrapanel reconfiguration without having to disassemble the panel, such as may be done externally, the current and/or voltage can be tuned at the installation site. For example, changing the voltage level of a string of modules has the benefit of enabling that module string to be tuned to the optimal voltage levels for a particular DC-to-AC inverter used for a particular solar panel array. Further, increasing the voltage over time carries the benefit of countering, for example, the gradual performance degradation that all solar panels conventionally experience as they age. Thus, the invention may be operated on-the-fly, i.e., during operational life-time of the solar panel array.

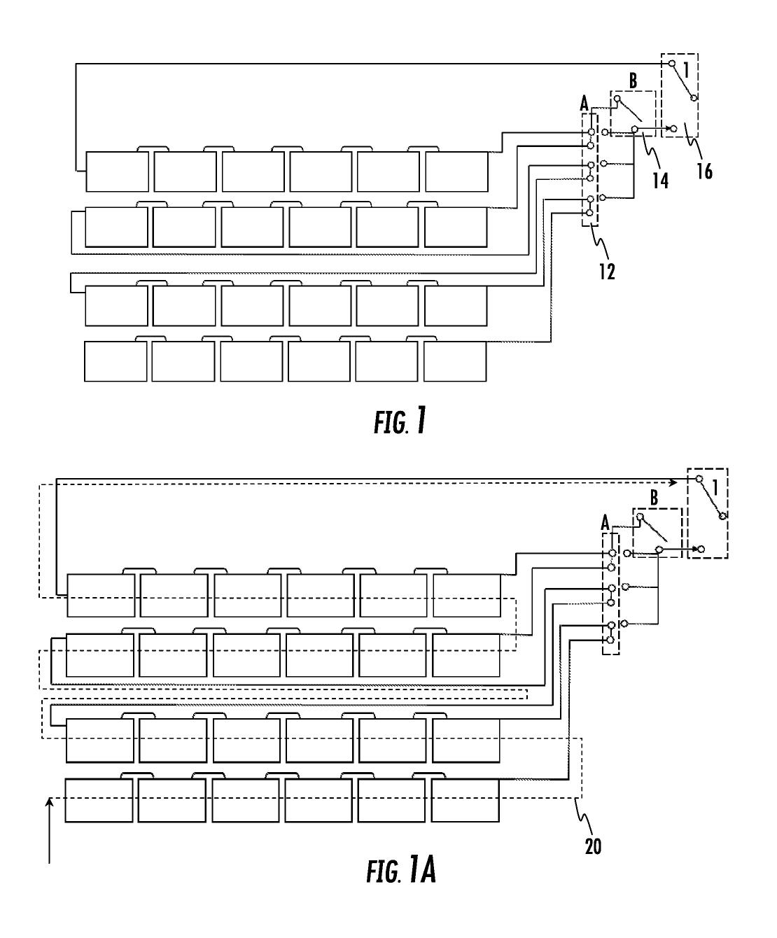

Referring now to FIG. 1, many typically known solar panels have their solar cells fixedly connected in series within a long string where the panel voltage is built up by the addition of the individual cell voltage for each cell connected in series. FIG. 1 shows a schematic of an embodiment having a first tier of switches 12 and a second tier of switches 14, used with a third tier of switches 16. Of course, any number of tiers may be used.

The switches may be any type of switch. These may include mechanical slider type switches such as manual electric switches that are packaged in a group in a standard dual in-line package (DIP) or DIP switches. The switches can be selected to handle the current and voltage from the solar panel. Some embodiments may use a plurality of Switronic Industrial slide switches TS series. Some embodiments may use a plurality of Switronic Industrial slide switches SK series. Some embodiments may use a plurality of Switronic Industrial slide switches IS series. For DIP switches, some embodiments may use a plurality of Switronic Industrial DIP switch DI or DM series. For DIP switches, some embodiments may use a plurality of Switronic Industrial DIP switch SPST series. For DIP switches, some embodiments may use a plurality of Switronic Industrial DIP switch DS, DA, or DP series. Selection of the switches may be based on those that allow the current and voltage levels anticipated for the circuit leading into the switch controller. For example, if a cell string generated 6 Amps and 50 V, the switch is properly capable of managing at least that amount of current and voltage over at least the typically twenty five year duration of the panel lifetime. Of course, other non-ideal switches are suitable.

FIG. 1A shows that the schematic of FIG. 1 is configured to have all the solar cells wired in series as indicated by the dotted line 20. This shows that with the tiers of switches in A, B, and C (FIGS. 1, 12, 14, and 16) properly switched the panel is configurably switched to select all cells in the system series. The tiers A, B and C can also be switched to arrange one or more rows of cells in a series connection arrangement. The configuration of dotted line 20 where all cells are selected in series can emulate the functional equivalent of a traditional serial circuit embodiment. Such a traditional series arrangement illustrates how this embodiment may be used in the present field without any special changes on the output side, for example, on the inverter or grid side. In other words, the instant embodiment is backwards compatible with legacy solar power systems existing today. Of course, other arrangements can be configured through the switching of the tiers.

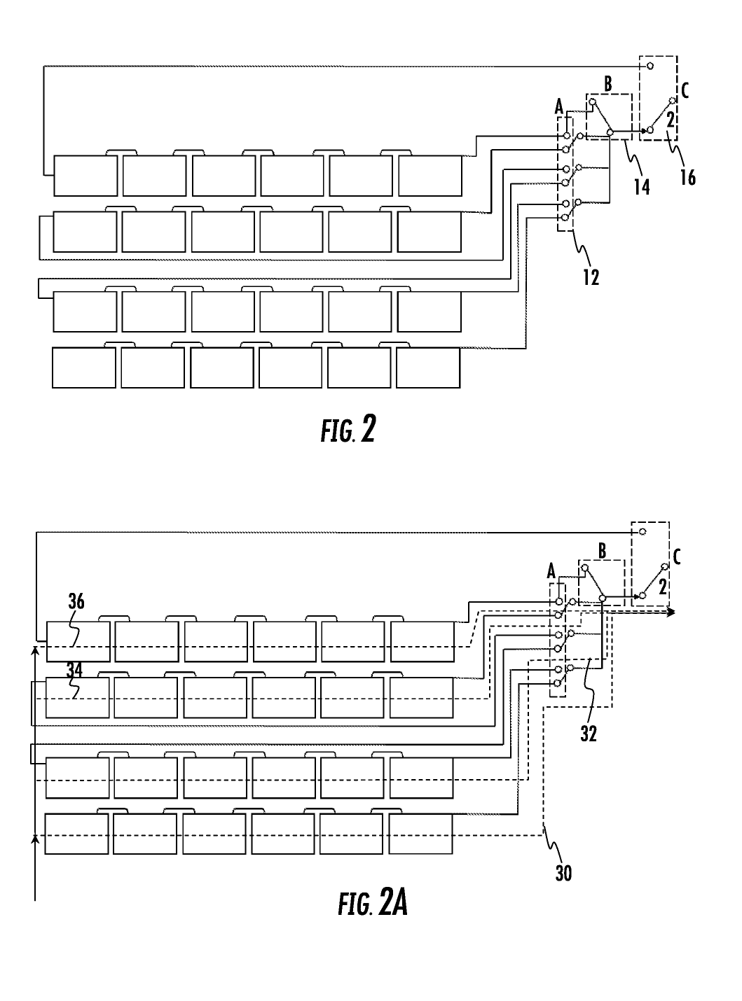

For example, FIG. 2 shows that the tiers of switches in 12, 14, and 16 may be configured to each have a “string” of cells, with each series string of cells being in parallel connection arrangement with at least another string. Here, for example, the cells of each string may be arranged fixedly with respect to each other. The switching arrangement, here in the form of tiers, is switched to provide combinations of one or more strings of cells in series acting independently or combined with other strings. In this manner arrangements of the cells can be arranged in serial and/or parallel connection arrangements.

The tiers can be located in a separate housing on the back of the solar panel, in the junction box housing, or if edge mounted junctions boxes are used, each of these edge mounted boxes can both (or only one) contain switches. The switches or tiers can also be arranged in an inverter or other switch box, for example.

FIG. 2b shows that the strings of cells are configured in parallel as indicated by phantom lines 30, 32, 34, and 36. This illustrates how the same solar panel with the switching provided by the tiers of switches in 12, 14, and 16 may allow the solar panel to be reconfigured to adjust output voltage by reconfiguring the wiring of the solar cells at the factory, during panel transportation to an installation site, or at the installation site. At the installation site, the configuration may be performed either during initial installation, or during the maintenance of the system over its lifetime, or both.

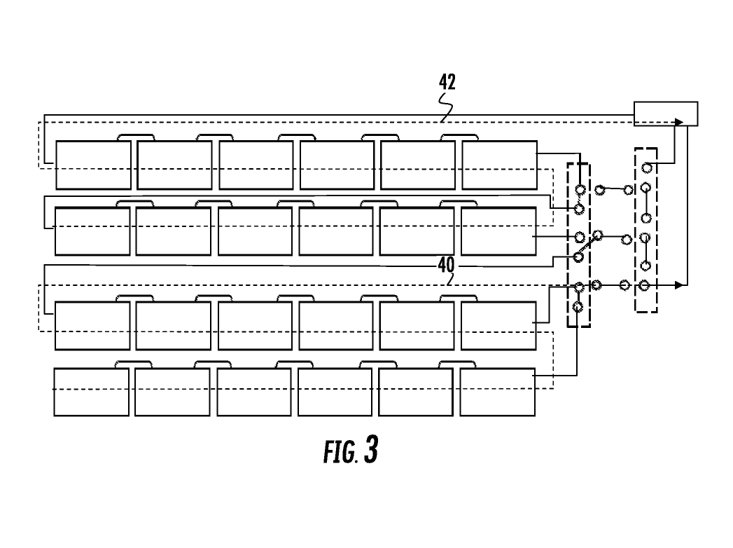

FIG. 3 shows yet another embodiment wherein there are two pairs of strings, with each pair made up of two strings of cells, each connected in series. Here, the tiers are switched such that each pair is arranged in a parallel connection arrangement. The two phantom lines 40 and 42 in FIG. 3 show the cells in series within the strings, but the strings are in parallel relative to each other. This is an example of a configuration which decreases the voltage level of a panel from what would be possible if that panel had all of its cells wired 100% in series. To reiterate, any configuration of strings is possible and the figure here only exemplifies the possibilities.

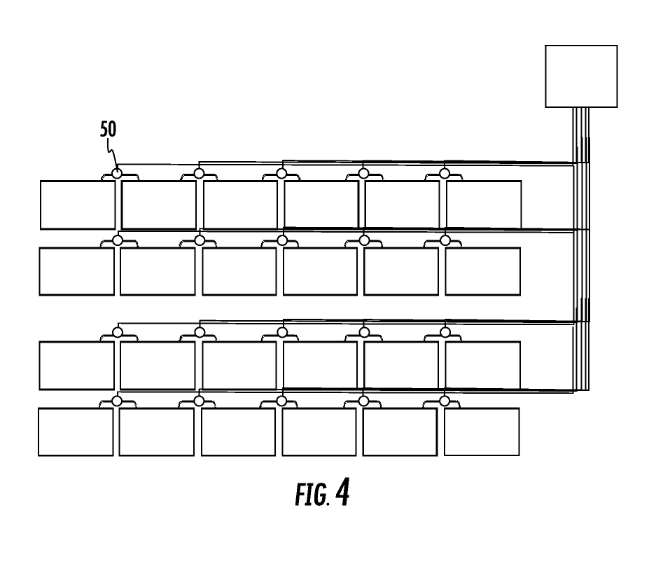

FIG. 4 shows a still further embodiment wherein there are switches 50 on each interconnection between cells. In the particular figure, the switches are connected in between cells of different strings. In this regard, the number of cells in each string can be operatively selected.

There may be provided for any of the embodiments physical switches (mechanical, and/or electrical, and/or solid state) at the actual junctions, for example. Alternatively, there may be logical switches in a programmable logic controller or PLC or similar device wherein one or more of the solar cells are individually wired to have its own wire path to the controller, allowing individual cells to be combined in the manner desired.

A programmable logic controller (PLC) or programmable controller is a digital computer used for automation of electromechanical processes. A PLC is typically designed for multiple inputs and output arrangements, extended temperature ranges, immunity to electrical noise, and resistance to vibration and impact. The nature and programming of a PLC or other controller is so well-known that the skilled artisan will readily understand how to program a computer.

Products called PLRs (programmable logic relays), and also by similar names, have become more common and accepted. These are very much like PLCs, and are used in light industry where only a few points of I/O (i.e. a few signals coming in from the real world and a few going out) are involved, and low cost is desired. These small devices are typically made in a common physical size and shape by several manufacturers, and branded by the makers of larger PLCs to fill out their low end product range. Popular brands include PICO Controller, NANO PLC, and other names implying very small controllers. Most of these have between 8 and 12 digital inputs, 4 and 8 digital outputs, and up to 2 analog inputs. Size is usually about 4″ wide, 3″ high, and 3″ deep. Most such devices include a tiny postage stamp sized LCD screen for viewing simplified ladder logic (only a very small portion of the program being visible at a given time) and status of I/O points, and typically these screens are accompanied by a 4-way rocker push-button plus four more separate push-buttons, similar to the key buttons on a VCR remote control, and used to navigate and edit the logic. Most have a small plug for connecting via RS-232 or RS-485 to a personal computer so that programmers can use simple Windows applications for programming instead of being forced to use the tiny LCD and push-button set for this purpose. Unlike regular PLCs that are usually modular and greatly expandable, the PLRs are usually not modular or expandable, but their price can be two orders of magnitude less than a PLC and they still offer robust design and deterministic execution of the logic.

Furthermore, any of the embodiments may further include a computer for operating the switches and selectively connecting the cells through the switching of the interconnections. In addition, the programming for operating such a computer to switch the switches, which may include switching over time, may be stored on any storage medium, including a non-transitory storage medium. For that matter, the switching may be controlled remotely from a central station, using any number of communication methods, including broadband, mobile communication or satellite. Programming computers is readily understood without further explanation and the skilled artisan will understand how to program a computer or store the same on a storage medium.

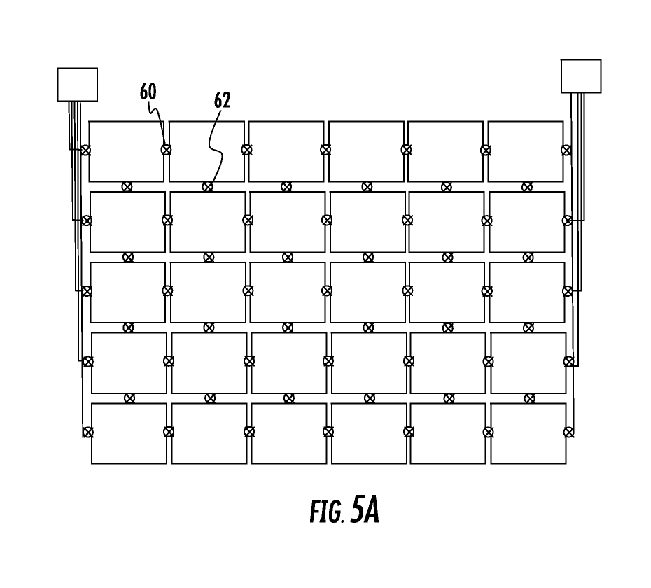

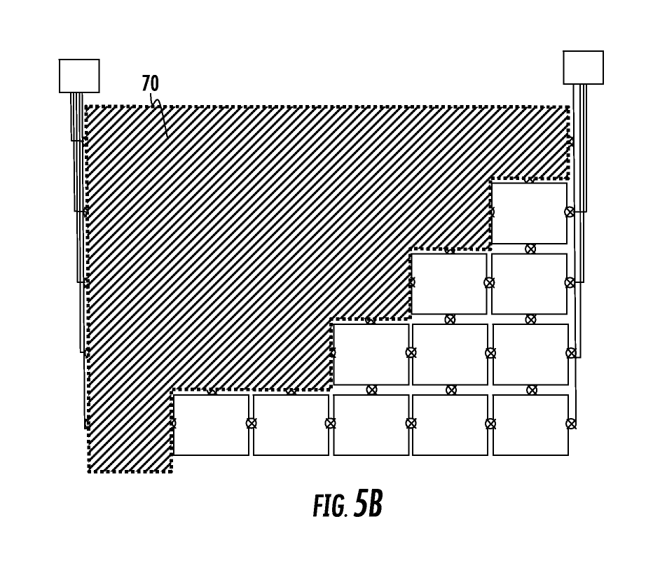

FIG. 5A shows yet another embodiment wherein multiple switches 60 are arranged on each interconnection between cells. In addition, the switches may be between any neighboring cell. This provides a matrix array of cells where any individual cell can be selected by operation of the switches. In that regard, the array can be addressed according to row and column. Of course, the matrix need not be a symmetrical matrix, such as a square, but may have staggered cells such that the matrix can have any shape. In this manner, any individual cells may be selected to form any pattern of cells possible. This could take into account, for example, degradation of all or particular cells, environmental conditions such as light variations across different cells, or other factors.

In one example, the cells are of different size or type. In that regard, the various cells may be switched according to a need for a particular cell size and/or type. This allows the cells to be mixed and matched bringing together any size or type of cell for the first time onto the same panel.

The switches may be physical switches (mechanical, and/or electrical, and/or solid state) at the actual junctions. In addition or alternatively, the switches may be logical switches in a programmable controller wherein one, more, or all of the solar cells are individually wired to have its own wire path to the controller. In either case, individual cells are allowed to be combined in the manner desired. The path, for example, may be controlled in x axis and y axis. However, the solar panel is not limited to a number of dimensions and my include three dimensions, such as in a 3D solar cell. In addition, the array may not necessarily be symmetrical and may have staggered cells to form any shape.

The junctions in between neighboring cells on any side may also be incorporated with switches or individually wired as illustrated generally by reference numeral 62. With such vertical connection switches 62, each path can be controlled to provide different types of active areas of the solar panel. In multidimensional systems, such as those used in space, the junctions may be between 3D solar cells, such as back to back solar panels used on the international space station.

FIG. 5B shows the embodiment of FIG. 5A in operation. Here, select area 70 in cross-hatch is switched to be active, while other areas are switched to be bypassed or otherwise arranged in parallel with other cells in the non-hatched region. Multiple areas may, thus, be bypassed or arranged in parallel.

The various embodiments may be combined. For example, the strings of cells and switching tiers discussed with reference FIGS. 1-4, for example, may be combined with the switches incorporated between cells as in FIGS. 5a and b. In that regard, any combination strings and individual cells may be selected.

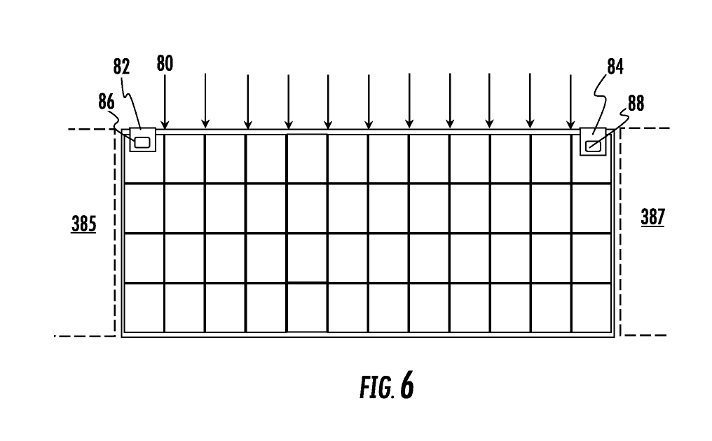

FIG. 6 shows a bottom-up plan view wherein the wires (insulated flat, round, or other shaped) can be mounted in gaps 80 between strings of cells. This fills the existing gap between cells to fill areas that are not used and will provide improved aesthetic appearance by filling these gaps. These will also conserve space and avoid damage to the wires or other objects in space critical applications such as solar panels for space vehicles or satellites.

Adjacent modules 385 and 387 are shown in phantom. FIG. 6 also shows each edge box 82 and 84 with its own set of switches 86 and 88. These switches 86 and 88 can both be changed or only one changed to provide the desired configuration.

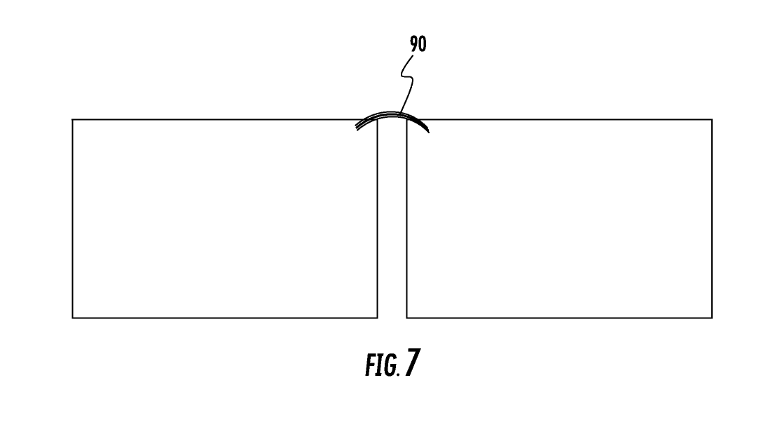

FIG. 7 shows yet another embodiment wherein two or more solar panels can be configured to form a “single” panel through one or more wire interconnections 90 that allow a controller (through mechanical or electrical switches) to change the voltage (or current) output. For example, by operation of the switching, this embodiment allows two or more solar panels to match that of one very large panel. The number of wires in the ribbon 90 can be the number of cells in the adjacent panel, the number of strings in the adjacent panel, or otherwise, depending on the granularity of control desired. To reiterate, any combination is possible.

Now an example is provided in operation. To begin with, by operation of the switches, a tuning of the voltage to a particular target value is enabled. In one alternative, the voltage (or current) may be tuned to feed power to an inverter that is in the optimum range or “sweet spot” for that inverter's efficiency. In more detail, for a particular power level a given inverter typically operates at peak efficiency for a certain voltage level. By configuration of the cell strings within each panel, the addressable array or any of the embodiments enables the tuning of a module string's voltage to a voltage which enables high inverter efficiency. That is the power level is properly set for that particular inverter.

Furthermore, the optimization of inverter function can be adjusted overtime. This may be programmed as an automatic function such that the optimization is controlled by a computer on the basis of predetermined parameters. These parameters may include degradation of one or more cells as will be explained in more detail. Thus, this embodiment increases the overall system-level performance of a solar panel array. In one alternative, for example, performance may be measured or determined by an increased performance ratio of the panel and/or a decreased levelized cost of energy of the system.

Next, this embodiment allows for the optimization of the solar panel system as more cells degrade. In order to counteract degradation, the power output of the solar panel system can be manually adjusted higher. However, this is not an ideal way to handle degradation. First, the power output has to be reset repeatedly each time the cells degrade. It is also likely that the initial power output of the panel is initially set to maximum. Then as the panel performance degrades (e.g. by way of non-limiting example, at the industry standard 0.8% per year or less), the output power cannot be increased to compensate. This embodiment resolves these problems. For example, the power output can be regained and degradation minimized by reconfiguring the panel while in the field (the panel is in service), and even configured continuously or on-the-fly, thereby achieving a higher voltage level than was initially configured. Since power is determined by the multiplication of current and voltage, the power output can be increased through this reconfiguration. In this manner the performance degradation typical of solar panels is minimized or even eliminated, even over many years.

By use of wires that are coated with insulating material (such as an insulating polymer), when wires are arranged between cell strings in a panel, their geometric position may be used to physically block potential contact between cell strings. To explain, contraction and expansion over years could otherwise lead to potential shorts at places where cells in neighboring rows make electrical contact. In this manner the insulating sheath around each wire, when placed in the proper position, serves as a short-inhibiting material, and increases the reliability of the panel. In case, it does occur that certain cells fail due to shorting or are defective, the embodiment may also switch the array to bypass the defective cell. Such an arrangement may be advantageous for small sized or micro solar cells that are manufactured en masse. In that case, the defective solar cells may simply be switched off.

A discussion of the optimization of the extent of cell and/or cell string configurability in a panel will now be set forth. Dependent on the cell string-to-controller switch wire cost and cell string-to-controller switch wire resistance, there may be differential benefit in making a sub-portion of the panel addressable. By minimizing cost and minimizing resistive losses as charge is carried over the wires leading to the switching circuitry, the potential advantages of increased voltage and power can be designed to outweigh the potential disadvantages of incrementally increased component cost and potential resistive losses as charge moves through the string-to-controller switch wires.

For example, the range of potentially useful voltage outputs for a particular class of inverters can be determined, and the panel can be designed to enable voltage variation in that range, which may require only one or a few cells or cell strings to be configurable. In another example, some may have cells in one string that are individually or in groups (such as but not limited to two or three) couple-able in parallel to change the output voltage. Similarly, the range of potentially useful voltage outputs desired to maintain power over slow performance degradation can be determined, and the panel designed to enable incremental voltage increases to maintain power over the panel lifetime, which may require only one or a few cells or cell strings to be configurable.

For example, in one embodiment, and by way of non-limiting example, 20% or less of the cells in the panel are in the portion(s) that can be reconfigured. Optionally, and by way of non-limiting example, 15% or less of the cells are in the portion(s) that can be reconfigured. Optionally, and by way of non-limiting example, 10% or less of the cells are in the portion(s) that can be reconfigured. Optionally, and by way of non-limiting example, 5% or less of the cells are in the portion(s) that can be reconfigured.

Optionally, wiring used internally for coupling solar cells or solar cell strings to the controller switch may be highly conductive with minimal resistive loss and enabling sufficiently high voltage, such as but not limited to flat wire that can carry 10 amps of current at 50 V of voltage with minimal resistive loss. Examples of such products are available from Allied Electronics of Fort Worth, Tex. Some may use aluminum, copper, or their alloys. The wires may have a sheath or coating of electrically insulating material. The wires may have a high cross-sectional aspect ratio, in terms of height and width. Optionally, the intrapanel wires coupling the cells to the controller may have an external height of 1 mm or less, such as the dimensions typically found in “flat” or “ribbon” type wires.

The measurement of solar panel system performance, which may include cost, is one manner for establishing predetermined parameters for controlling the switching of the cells. Other measurements or parameters for controlling the switching of cells are also options.

The performance ratio may be defined as the relationship between the actual returns and theoretically potential energy returns of a photovoltaic system. The performance ratio is an appropriate valuation criterion for determining the quality of the plant configuration, because all components and their interaction are considered. The performance ratio may be independent of the orientation of a photovoltaic system and the global radiation. The Levelized Cost of Energy (LCOE) is an economic assessment of the cost of the energy-generating system including all the costs over its lifetime: initial investment, operations and maintenance, cost of fuel, and cost of capital. The LCOE equation is an evaluation of the life-cycle energy cost and life-cycle energy production. In one embodiment, the performance ratio with respect to the LCOE is taken into account to determine when and which cells should be switched.

One embodiment allows for integration with or incorporation into an inverter. An inverter is an electrical device that converts direct current (DC) to alternating current (AC). The electrical inverter is a high-power electronic oscillator. It is so named because early mechanical AC to DC converters were made to work in reverse, and thus were “inverted”, to convert DC to AC. Inverter input voltage depends on inverter power, for small power of some 100 W the voltage is 12 or 24 V, and 48 V or more for higher power.

A grid-tie inverter, or a (GTI) is a special type of inverter that is used in a renewable energy power system to convert direct current into alternating current and feed it into the utility grid. The technical name for a grid-tie inverter is “grid-interactive inverter”.

An inverter can be measured based on a range of characteristics, including but not limited to: (i) Rated Output Power: which provided in watts or kilowatts, (ii) Output voltage(s): which indicates to which utility voltages the inverter can connect, (iii) Peak efficiency: which represents the highest efficiency that the inverter can achieve.

Most grid-tie inverters on the market have peak efficiencies of over 94%. The energy lost during inversion is for the most part converted into heat. (iv) CEC weighted efficiency: This efficiency is published, for example, by the California Energy Commission on its GoSolar website. In contrast to peak efficiency, this value is an average efficiency and is a better representation of the inverter's operating profile. Inverters that are capable of producing power at different AC voltages may have different efficiencies associated with each voltage. (v) Maximum input current: which is the maximum amount of DC current that the inverter will use. (vi) Peak Power Tracking Voltage: which represents the DC voltage range in which the inverters' maximum point power tracker will operate. Another parameter of importance here is (vii) Start Voltage: The value indicates the minimum DC voltage that is required in order for the inverter to turn on and begin operation. Start voltage is important for solar applications, because the system designer must be sure that there is a sufficient number of solar modules wired in series in each string to produce this voltage.

The system designer strives to configure the strings optimally so that during the majority of the year, the voltage of the strings will be within this range. This can be a difficult task since voltage will fluctuate with various parameter changes, such as variations in temperature. The addressable array described in embodiments permit the inverter to be add to the performance ratio and decrease the levelized cost of energy at the system level. For example, inverters that are capable of producing power at different AC voltages may have different efficiencies associated with each voltage, and being able to tune to a certain voltage can change the inverter efficiency, potentially improving that efficiency. As will now be described, one embodiment provides an automatic manner in which the output is optimized taking into account these various parameters. In particular, optimization of the inverter function and its impact on system level performance and cost will now be described.

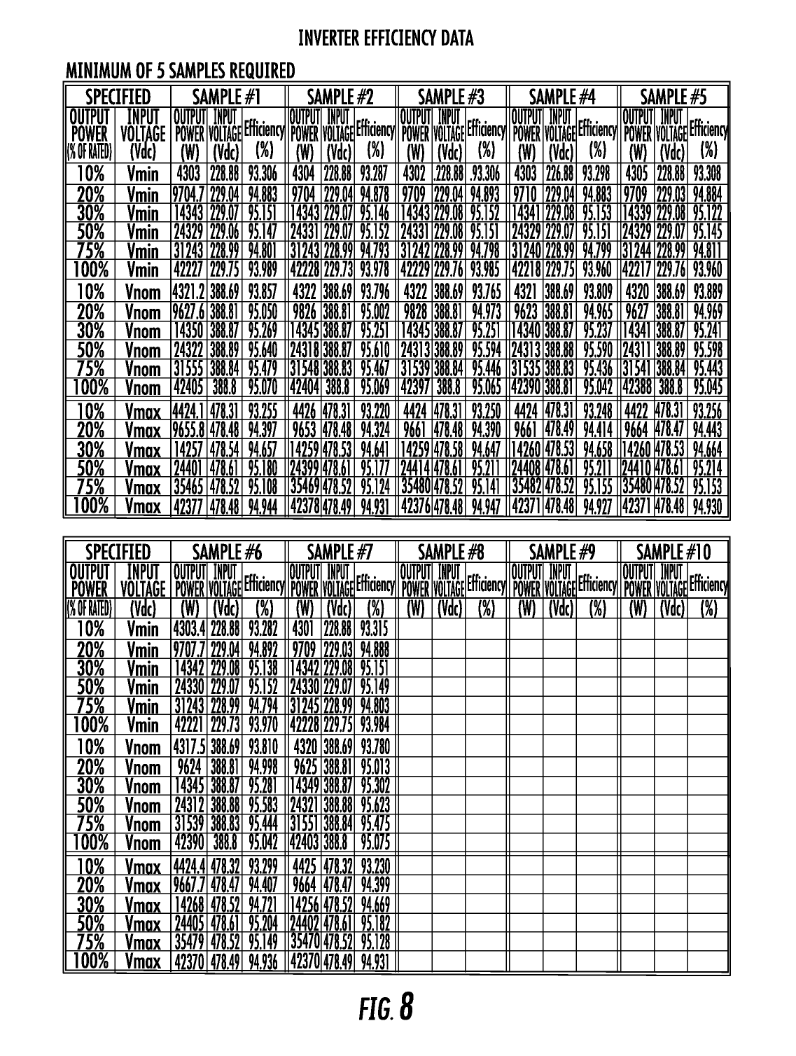

By way of non-limiting example, FIG. 8 shows a table illustrating actual inverter performances. Here it is seen that, as input voltage from the solar panel changes, it is demonstrated that the inverter efficiency also changes. Thus, it is desirable to adjust the voltage output of the panel over time to maintain inverter efficiency in the higher ranges. This embodiment employs this stochastic data to program its switching routine, which switches the cells over time, in order to arrive at an optimized output for the particular inverter. By employing different data for different types of cells or panels, this embodiment further may optimize output for any inverter or system.

As another example, peak power tracking voltage (the DC voltage range in which the inverter will maximally operate) can be difficult to determine since voltage changes with panel temperature, time of day, and time of year (season). The embodiment may also tune the panel voltage in order to minimize performance impact of these ambient daily and/or seasonal temperature fluctuations can be minimized In particular areas where the weather can be predicted, such as desserts, the invention can select the correct cells or strings to adjust for lighting fairly accurately.

Another example, takes into account the start voltage for a particular inverter. This is done by tuning the panel voltage to ensure a particular module string voltage is always over the start voltage required for inverter operation. These start voltages may be programmed into the computer or controller that operate the switches in order to select the correct combination of cells for a particular type of inverter.

While the above is a complete description of one or more embodiments of the present invention, it is possible to use various alternatives, modifications and equivalents. For example, those of skill in the art will recognize that any of the embodiments of the present invention can be applied to almost any type of solar cell material and/or architecture. For example, they may be single junction cells or multiple junction cells.

It should also be understood that any of the embodiments herein can also be configured for use with concentrating photovoltaic (CPV) systems which are systems that include optical elements positioned to increase the amount of light directed to a photovoltaic cell. These can be known concentrator photovoltaic devices High concentration photovoltaics (HCPV) systems employ concentrating optics consisting of dish reflectors or fresnel lenses that concentrate sunlight to intensities of 300 suns or more, medium concentration photovoltaics with concentrations of 100 to 300 suns, or low concentrating devices or panels with a solar concentration of 2-100 suns. Some embodiments may use traditional optics for light concentration, or optionally, some may use flat coatings or glass such Cool Mirror film from 3M. Further the solar cell may be assembled using light absorbing materials that include any of silicon, polycrystalline silicon, micromorphous silicon, or amorphous silicon, or Cadmium Telluride or similar materials, Cadmium Selenide or similar materials.

Further the solar cell may be assembled using organic oligomers or polymers (for organic solar cells), bi-layers or interpenetrating layers or inorganic and organic materials (for hybrid organic/inorganic solar cells), dye-sensitized titania nanoparticles in a liquid or gel-based electrolyte (for Graetzel cells in which an optically transparent film comprised of titanium dioxide particles a few nanometers in size is coated with a monolayer of charge transfer dye to sensitize the film for light harvesting), and/or combinations of the above, where the active materials are present in any of several forms including but not limited to bulk materials, micro-particles, nano-particles, or quantum dots

Additionally, other possible absorber layers may be based on amorphous silicon (doped or undoped), a nanostructured layer having an inorganic porous semiconductor template with pores filled by an organic semiconductor material, a polymer/blend cell architecture, organic dyes, and/or C60 molecules, and/or other small molecules, micro-crystalline silicon cell architecture, randomly or non-randomly placed nanorods and/or tetrapods of inorganic materials dispersed in an organic matrix, quantum dot-based cells, or combinations of the above. Many of these types of cells can be fabricated on flexible substrates. Cells constructed from either flexible and/or rigid substrates or mixtures of flexible and rigid substrates may be used with this invention.

Therefore, the scope of the present invention should be determined not with reference to the above description but should, instead, be determined with reference to the appended claims, along with their full scope of equivalents. In the claims that follow, the indefinite article “A”, or “An” refers to a quantity of one or more of the item following the article, except where expressly stated otherwise. The appended claims are not to be interpreted as including means-plus-function limitations, unless such a limitation is explicitly recited in a given claim using the phrase “means for.”

What is claimed is:

1. An apparatus for configuring photovoltaic cells, the apparatus comprising:
an array of photovoltaic cells arranged as a matrix; and
a plurality of interconnections arranged between the photovoltaic cells, the interconnections being switchably addressable to form serial or parallel connection arrangements.

2. The apparatus according to claim 1, wherein the interconnections are switchable such that the serial or parallel connection arrangements can be altered post-production.

3. The apparatus according to claim 1, wherein the interconnections are switchable such that the serial or parallel connection arrangements can be altered in an outdoor operating environment.

4. The apparatus according to claim 1, wherein voltage arising from the array is tuned by switching a number of the interconnections of the photovoltaic cells in series.

5. The apparatus according to claim 1, wherein voltage arising from the array is tuned by switching a number of the interconnections of the photovoltaic cells in parallel.

6. The apparatus according to claim 4, wherein voltage is tuned to optimize electronic performance of an inverter component downstream from the array.

7. The apparatus according to claim 5, wherein the voltage is tuned to optimize electronic performance of an inverter component downstream from the array.

8. The apparatus according to claim 6, wherein the electronic performance is measured by AC to DC conversion efficiency.

9. The apparatus according to claim 7, wherein the electronic performance is measured by AC to DC conversion efficiency.

10. The apparatus according to claim 5, wherein the number of photovoltaic cells interconnected in parallel is switched using a switch selected from the group consisting of: a dip switch; a mechanical, electrical, or sold-state switch; a programmable logic controller; a programmable logic relay; or any combination of one or more switches of the group.

11. The apparatus according to claim 6, wherein the number of photovoltaic cells interconnected in parallel is switched using a switch selected from the group consisting of: a dip switch; a mechanical, electrical, or sold-state switch; a programmable logic controller; a programmable logic relay; or any combination of one or more switches of the group.

12. A method for configuring photovoltaic cells, the photovoltaic cells arranged in a matrix forming an array of a solar power system, wherein a plurality of photovoltaic cells are addressable by one or more interconnections that switchably connect the photovoltaic cells to form serial or parallel connection arrangements, the method comprising the steps of:
tuning the voltage arising from the matrix by switchably selecting one or more of the interconnections to arrange a number of photovoltaic cells in a parallel connection arrangement; and
switching one or more of the interconnections over time to optimize a performance ratio of the solar power system, wherein the array is contained within a solar panel and the solar power system is comprised of a string of solar panels that are similar to the solar panel.

13. A method for configuring photovoltaic cells, the photovoltaic cells arranged in a matrix forming an array of a solar power system, wherein a plurality of photovoltaic cells are addressable by one or more interconnections that switchably connect the photovoltaic cells to form serial or parallel connection arrangements, the method comprising the steps of:
tuning the voltage arising from the matrix by switchably selecting one or more of the interconnections to arrange a number of photovoltaic cells in a series connection arrangement; wherein the voltage is tuned to optimize the electronic performance of an inverter component downstream from the matrix addressable array; and
switching one or more of the interconnections over time to optimize the performance ratio of the solar power system, wherein the matrix-addressable array is contained within a solar panel and the solar power system is comprised of a string of solar panels, that are similar to the solar panel.

14. The method according to claim 12, wherein the step of switching counteracts performance degradation of the solar power system as the solar power system ages.

15. The method according to claim 13, wherein the step of switching counteracts performance degradation the solar power system as the solar power system ages.

16. The method according to claim 12, wherein the step of switching counteracts loss of performance of the solar power system as the solar power system is exposed to a range of times of day or seasons or operating temperatures.

17. The method according to claim 13, wherein the step of switching counteracts loss of performance of the solar power system as the solar power system is exposed to a range of times of day or seasons or operating temperatures.

18. The method of claim 12, wherein the step of switching tunes a voltage onset of a solar power system to an inverter for the solar power system.

19. The method according to claim 13, wherein the step of switching tunes a voltage onset of the solar power system to an inverter for the solar power system.

20. The method according to claim 12, wherein the photovoltaic cells or switching wiring incorporates wires that are coated with insulating material; and further comprising the step of arranging the wires between photovoltaic cell strings in a panel, wherein the geometric position of the wires is arranged such that they physically block contact between cell strings whose contraction and expansion over time leads to potential shorts at places where cells in neighboring rows make electrical contact.

21. The method according to claim 13, wherein the photovoltaic cells or switching wiring incorporates wires that are coated with insulating material; and further comprising the step of arranging the wires between photovoltaic cell strings in a panel, wherein the geometric position of the wires is arranged such that they physically block contact between cell strings whose contraction and expansion over time leads to potential shorts at places where cells in neighboring rows make electrical contact.
